(19) United States
(12) Patent Application Publication
(10) Pub. No.: US 2002/0090434 A1
(43) Pub. Date: Jul. 11, 2002

(54) Powder of unhulled cereal grains and method of manufacturing the same

(76) Inventor: Yasuhiro Toyokura, Kanagawa (JP)

Correspondence Address: HARNESS, DICKEY & PIERCE, P.L.C., P.O. BOX 828, BLOOMFIELD HILLS, MI, 48303, US

(21) Appl. No.: 10/034,774

(22) Filed: Dec. 28, 2001

(30) Foreign Application Priority Data
Jun. 21, 2000 (JP) PCT/JP00/04056
Jul. 2, 1999 (JP) 11-189416

(51) Int. Cl. A23L 1/00

(52) U.S. Cl. 426/456; 426/507; 426/466; 426/463

(57) ABSTRACT

Provided is a powder of unhulled rice grains having a nutrient value higher than that of a powder of unpolished rice grains, being excellent in digestive and absorptive properties, and providing a good foodstuff. The powder is manufactured by immersing uncooked rice grains in water for a predetermined time, followed by roasting the grains for a predetermined time and subsequently powdering the roasted grains. The powder can be manufactured from other cereal grains such as barley, wheat, rye and oat than rice.

### TECHNICAL FIELD

The present invention relates to a powder of unhulled cereal grains useful as foodstuff, beverage, livestock feed and so forth, and to a method of manufacturing the same

### BACKGROUND ART

Various treatments are applied to rice, which is a typical cereal, before rice is cooked. Specifically, the hull is removed from the threshed rice to obtain unpolished rice, which is further subjected to rice cleaning to obtain polished rice. In general, the unpolished rice or polished rice is used for cooking. Since the unpolished rice, if powdered, is converted into beta form and turned into paste, which is unsuitable to storage, it was considered impossible for a long time to powder the unpolished rice.

As a result of an extensive research on the powdering of the unpolished rice, the present inventor has succeeded in powdering of the unpolished rice by roasting the unpolished rice in advance and has obtained a patent right on the roasting apparatus (Japanese Patent Examined (KOKOKU) Publication No. Hei 3 (1991)-56726).

The powder prepared by powdering the unpolished rice after roasting is very rich in nutrient because the nutrients of the unpolished rice remain as they are in the powder. Also, the digestive and absorptive properties are markedly improved by the powdering, though the unpolished rice is said to be defective in these properties. Such being the situation, the powdered unpolished rice has been widely popularized.

During the research on manufacture of various powders of unpolished rice under various roasting conditions of the unpolished rice, the present inventor has found that the unpolished ice powdered after roasted black has a higher nutrient value per unit weight and exhibits improved digestive and absorptive properties than those of the powder with shorter roasting time. Through being roasted black before powdering, the powdered unpolished rice has a high carbon content. The present inventor tried to roast the unhulled rice grain on the assumption that the carbon content would have some relationship with the nutrient value and with the digestive and absorptive properties of rice.

As widely known to the art, it is difficult to dispose of the agricultural waste material of the rice hull. For disposing of the rice hull by means of burning, it is necessary to burn the rice hull at a considerably high temperature. Also, even if buried in the ground, the rice hull is not reduced to the soil. These problems are derived from the composition of the rice hull. Specifically, the rice hull contains about 71 to 87% of organic components including mainly α-cellulose and lignin, and about 13 to 29% of the ash components. Further, silicon contained in the form of amorphous silica in the ash component amounts to 95%.

It is quite inconceivable in view of the common sense to use the rice hull of the particular composition as foodstuff. As a matter of fact, the idea of using the rice hull as foodstuff has not yet been proposed at all.

### DISCLOSURE OF INVENTION

An object of the present invention is to provide a powder of unhulled cereal having a high nutrient value, excellent in digestive and absorptive properties, and useful as foodstuff, beverage, livestock feed and so forth, which is beyond the conventional common sense, and a method of manufacturing the same.

According to one aspect of the present invention, there is provided a powder of unhulled cereal grains prepared by the following steps of impregnating unhulled cereal grains with water, roasting the impregnated grains, and powdering the roasted grains.

The cereal grains comprise at least one cereal selected from the group of rice, barley, wheat, rye and oats.

According to another aspect of the present invention, there is provided a method of manufacturing a powder of unhulled cereal grains, comprising the steps of impregnating unhulled cereal grains with water for a predetermined time, roasting the impregnated grains for a predetermined time, and pulverizing the roasted grains into fine powder.

It is desirable to roast the unhulled cereal grains until the grains are roasted brown or black.

### BEST MODE FOR CARRYING OUT THE INVENTION

In preparing the powder of, for example, unhulled rice grains, the unhulled rice grains after the threshing step are immersed in water for about 20 to 45 minutes. Then, the unhulled rice grains impregnated with water are put in a roasting pot constructed as disclosed in Japanese Patent Examined (KOKOKU) Publication No. Hei 3 (1991)-56726 and roasted until the grains are colored by roasting. This roasting should be performed while rotating the roasting pot so as to heat uniformly the unhulled rice grains put in the pot. The roasting time, which depends on the roasting temperature and the desired degree of roasting, is generally about 45 minutes to 3 hours. After completion of the roasting, the unhulled rice grains are taken out of the roasting pot, followed by pulverizing the roasted grains in a pulverizer to obtain a fine powder having a particle diameter not larger than 25 μm, thereby obtaining a powder of the unhulled rice grains of the present invention.

Some Examples of the present invention will now be described.

### EXAMPLE 1

Used were 30 kg of unhulled rice grains produced in Tochigi-ken, Japan, in 1998. The unhulled rice grains were immersed in water for 30 minutes, followed by roasting the grains impregnated with water in steps 1 to 6 as given below. In each step, the temperature of the grains was measured:

| | Roasting time | Temperature |
|---|---|---|
| Step 1 | 15 minutes | 70° C. |
| Step 2 | 15 minutes | 135° C. |
| Step 3 | 15 minutes | 167° C. |
| Step 4 | 15 minutes | 200° C. |
| Step 5 | 15 minutes | 214° C. |
| Step 6 | 5 minutes | 235° C. |

The total roasting time was 1 hour and 20 minutes. The roasted grains were taken out of the roasting pot when the unhulled rice grains were roasted pale brown. The rice grains within the hulls were found to have been finished brown.

The grains after the roasting were weighed, and the weight was found to be 26.5 kg, the roasting yield being 88.3%. Finally, the roasted grains were pulverized into a fine powder having an average particle diameter of about 20 μm, thereby obtaining the powder of the unhulled grains defined in the present invention.

The composition of the product powder was analyzed, with the results as shown in Tables 1 and 2:

TABLE 1
Analytical Result

| Analyzed | | | |
|---|---|---|---|
| Items | Result | Note | Analytical Method |
| Water | 1.8 g/100 g | | Drying method by hearing under |
| | | | normal pressure |
| Protein | 8.4 g/100 g | 1 | Kjeldahl method |
| Lipid | 3.9 g/100 g | | Acid decomposition method |
| Ash | 3.8 g/100 g | 2 | Direct ashing method |
| Glucide | 67.7 g/100 g | 3 | |
| Energy | 340 kcal/ | 4 | |
| | 100 g | | |
| Dietary | 14.4 g/100 g | | Oxygen-weight method |
| Fiber | | | |
| Sodium | 4.0 mg/100 g | | Atomic absorption Spectroscopy |
| Phosphorus | 330 mg/100 g | | Vanadomolybdic acid |
| | | | absorption spectroscopy |
| Iron | 5.84 mg/100 g | | O-Phenanthroline absorption |
| | | | Spectroscopy |
| Calcium | 19.7 mg/100 g | | Potassium permanganate |
| | | | volumetric analysis |
| Potassium | 279 mg/100 g | | Atomic absorption spectroscopy |
| Magensium | 132 mg/100 g | | Atomic absorbtion spectroscopy |

Notes:

1. Nitrogen/protein conversion coefficient: 5.95;

2. Calculation formula by nutrient indication standard (Notice No. 146, 1996, by the Ministry of Health and Welfare): 100−(water+protein+lipid+ash+dietary fiber); 3. Energy conversion coefficient by nutrient indication standard (Notice No. 146, 1996, by the Ministry of Health and Welfare): protein 4; lipid 9; glucide 4;

4. By AOAC method.

TABLE 2
Analytical Result

| Analyzed Items | Result | Note | Analytical Method |
|---|---|---|---|
| Riboflavin | 0.04 mg/100 g | | High speed liquid |
| (Vitamin B₂) | | | chromatography |
| Vitamin B₆ | 74 μg/100 g | 1 | Microorganism determination |
| | | | method |
| Total | 2.5 mg/100 g | | High speed liquid |
| tocopherols | | | chromotography |
| (Vitamin E) | | | |
| α-tocopherol | 2.1 mg/100 g | | |
| β-tocopherol | 0.1 mg/100 g | | |
| γ-tocopherol | 0.3 mg/100 g | | |
| Folic Acid | 9 μg/100 g | 2 | Microorganism determination |
| | | | method |
| Biotin | 6.6 μg/100 g | 3 | Microorganism determination |
| | | | method |
| Inositol | 271 μg/100 g | 1 | Microorganism determination |
| | | | method |
| Niacin | 7.08 mg/100 g | 3 | Microorganism determination |
| | | | method |
| Choline | 0.09 g/100 g | 4 | |
| Linoleic Acid | 1.08 g/100 g | | Gas chromatography |
| Linolenic Acid | 0.05 g/100 g | | Gas chromatography |
| Pepsin | 64.8% | 5 | |
| Digestion Rate | | | |
| Phytic Acid | 533 mg/100 g | | Vanadomolybdic acid |
| (as meso- | | | absorption spectroscopy |
| inositohexalic | | | |
| Acid) | | | |
| Zinc | 2.62 mg/100 g | | Atomic absorption |
| | | | spectroscopy |
| The Number of | 300 or less/g | | Standard ager plain plate |
| General Bacilli | | | culturing method |
| (the Number of | | | |
| Live Bacilli) | | | |
| Colon Bacilli | Negative/2.22 g | | BGLB method |

Notes:

1. Strain used: Saccharomyces cerevisiae (S. uvarum) ATCC 9080;

2. Strain used: Lactobacillus rhamosus (L. casei) ATCC 7469;

3. Strain used: Lactobacillus plantarum ATCC 8014;

4. By Reinecke's salt precipitation method;

5. Test condition: pepsin concentration, 0.2%; shaking digestion, 16 hours at 45° C.

### COMPARATIVE EXAMPLE 1

30 kg of unpolished rice grains prepared by removing the hulls from the threshed rice grains were immersed in water for 30 minutes, then roasted for 45 minutes. The temperature of the unpolished rice grains was elevated to about 200° C. The roasted unpolished rice grains were pulverized into a fine powder having an average particle diameter of about 20μm.

The analytical results of the fine powder were as shown in Tables 3 and 4:

TABLE 3
Analytical Result of Unpolished Rice

| Analyzed Items | Result | Note | Analyzed Items |
|---|---|---|---|
| Water | 2.0 g/100 g | | Drying method by heating |
| | | | under normal pressure |
| Protein | 7.5 g/100 g | 1 | Kjeldahl method |
| Lipid | 3.4 g/100 g | | Acid decomposition method |
| Ash | 1.4 g/100 g | | Direct ashing method |
| Glucide | 84.8 g/100 g | 2 | |
| Energy | 408 kcal/ | 3 | |
| | 100 g | | |
| Dietary fiber | 0.9 g/100 g | | Henneberg Stomann |
| | | | improving method |
| Sodium | 1.1 mg/100 g | | Atomic absorption |
| | | | spectroscopy |
| Phosphorus | 324 mg/100 g | | Vanadomolybdic acid |
| | | | absorption spectroscopy |
| Iron | 1.22 mg/100 g | | O-phenanthroline |
| | | | absorption spectroscopy |
| Calcium | 11.1 mg/100 g | | Atomic absorption |
| | | | spectroscopy |
| Potassium | 249 mg/100 g | | Atomic absorption |
| | | | spectroscopy |
| Magnesium | 119 mg/100 g | | Atomic absorption |
| | | | spectroscopy |
| Phytic acid (as | 635 mg/100 g | | Vanadomolybdic acid |
| mesoinositohexal | | | absorption spectroscopy |
| ic acid) | | | |

Notes:

1. Nitrogen/protein conversion coefficient: 5.95;

2. Calculation formula by nutrient indication standard (Notice No. 146, 1996, by the Ministry of Health and Welfare): 100−(water+protein+lipid+ash+dietary fiber);

3. Energy conversion coefficient by nutrient indication standard (Notice No. 146, 1996, by the Ministry of Health and Welfare): protein 3.47; lipid 8.37; carbohydrate (fiber+glucide) 4.12.

TABLE 4
Analytical Result of Unpolished Rice

| Analyzed Items | Result | | Note | Analytical method |
|---|---|---|---|---|
| Riboflavin | 0.04 mg/100 | g | | High speed liquid |
| (Vitamin B₂) | | | | chromatography |
| Vitamin B₆ | 0.32 mg/100 | g | 1 | Microorganism determination |
| | | | | method |
| Total | 1.7 mg/100 | g | | High speed liquid |
| tocopherols | | | | chromatography |
| (Vitamin E) | | | | |
| α-tocopherol | 1.5 mg/100 | g | | |
| γ-tocopherol | 0.2 mg/100 | g | | |
| Folic Acid | 24 μg/100 | g | 2 | Microorganism determination |
| | | | | method |
| Pantothenic | 0.72 mg/100 | g | 3 | Microorganism determination |
| acid | | | | method |
| Biotin | 5.7 μg/100 | g | 3 | Microorganism determination |
| | | | | method |
| Inositol | 155 mg/100 | g | 1 | Microorganism determination |
| | | | | method |
| Niacin | 6.77 mg/100 | g | 3 | Microorganism determination |
| | | | | method |
| Choline | 0.10 g/100 | g | 4 | |
| Linoleic acid | 1.08 g/100 | g | | Gas chromatography |
| Linolenic acid | 0.04 g/100 | g | | Gas chromatography |
| Zinc | 2.09 mg/100 | g | | Atomic absorption |
| | | | | spectroscopy |

Notes:

1. Strain used: Saccharomyces cerevisiae (S. uvarum) ATCC 9080;

2. Strain used: Lactobacillus rhamosus (L. casei) ATCC 7469;

3. Strain used: Lactobacillus plantarum ATCC 8014;

4. By Reinecke's salt precipitation method.

As shown in Table 1, the powder of the unhulled rice grains of the present invention (Example 1) was found to contain 67.7 g of glucide and to have 340 kcal of energy per 100 g of the powder. On the other hand, as shown in Table 3, the powder of the unpolished rice grains for Comparative Example 1 was found to contain 84.8 g of glucide and has 408 kcal of energy per 100 g of the powder. Clearly, the powder of the unhulled rice grains of the present invention provides a diet food having a very low energy, compared with the powder of the unpolished rice grains for Comparative Example 1. Also, the powder of the unhulled rice grains of the present invention was found to contain 14.4 g of dietary fiber per 100 g of the powder; whereas the powder of the unpolished rice grains for Comparative Example 1 was found to contain 0.9 g of dietary fiber per 100 g of the powder. In other words, the dietary fiber content of the powder of the present invention was 16 times as much as that for the powder of the unpolished rice grains for Comparative Example 1. Further, the powder of the present invention was found to contain 5.84 mg of iron and 19.7 mg of calcium per 100 g of the powder, whereas the powder for Comparative Example 1 was found to contain 1.22 mg of iron and 11.1 mg of calcium per 100 g of the powder. In other words, the iron content and the calcium content of the powder of the present invention were found to be about 4.8 times and 1.8 times as much, respectively, as the iron content and the calcium content for the powder of Comparative Example 1. Still further, the powder of the unhulled rice grains of the present invention was found to contain 2.5 mg of vitamin E per 100 g of the powder; whereas, the powder of the unpolished rice grains for Comparative Example 1 was found to contain 1.7 mg of vitamin E per 100 g of the powder. In other words, the vitamin E content of the powder of the present invention was about 1.5 times as much as that for the powder of Comparative Example 1. As pointed out above, the experimental data clearly support that the powder of the unhulled rice grains of the present invention, which provides a good diet food, also provides an attractive food containing large amounts of minerals, having a high nutrient value and being excellent in digestive and absorptive properties.

### PREFERRED EMBODIMENT 2

Used were 30 kg of unhulled rice grains produced in Tochigi-ken, Japan, in 1998. The unhulled rice grains were immersed in water for 30 minutes, then roasted according to steps 1 to 6 as given below:

| | Roasting time | Temperature |
|---|---|---|
| Step 1 | 15 minutes | 75° C. |
| Step 2 | 45 minutes | 157° C. |
| Step 3 | 15 minutes | 182° C. |
| Step 4 | 50 minutes | 201° C. |
| Step 5 | 30 minutes | 225° C. |
| Step 6 | 15 minutes | 238° C. |

The total roasting time was 2 hours and 50 minutes The roasted grains were taken out of the roasting pot when the unhulled rice grains were roasted black. The rice grains within the hulls were found to have been roasted black.

The grains after the roasting were weighed, and the weight was found to be 23.4 kg, the roasting yield being 78%. Finally, the roasted grains were pulverized into a fine powder having an average particle diameter of about 15 μm, thereby obtaining the powder of the unhulled grains defined in the present invention.

The composition of the product powder was analyzed, with the results as shown in Tables 5 and 6:

TABLE 5
Analytical Result

| Analyzed Items | Result | Note | Analytical method |
|---|---|---|---|
| Water | 1.0 g/100 g | | Drying method by heating |
| | | | under normal pressure |
| Protein | 7.9 g/100 g | 1 | Kjeldahl method |
| Lipid | 3.2 g/100 g | | Acid decomposition method |
| Ash | 4.6 g/100 g | | Direct ashing method |
| Glucide | 51.9 g/100 g | 2 | |
| Energy | 268 kcal/ | 3 | |
| | 100 g | | |
| Dietary fiber | 31.4 g/100 g | 4 | Oxygen-weight method |
| Sodium | 2.6 mg/100 g | | Atomic absorption |
| | | | spectroscopy |
| Phosphorus | 331 mg/100 g | | Vanadomolydbic acid |
| | | | absorption spectroscopy |
| Iron | 40.0 mg/100 g | | O-Phenanthroline |
| | | | absorption spectroscopy |
| Calcium | 21.7 mg/100 g | | Potassium permanganate |
| | | | volumetric analysis |
| Potassium | 320 mg/100 g | | Atomic absorption |
| | | | spectroscopy |
| Magnesium | 122 mg/100 g | | Atomic absorption |
| | | | spectroscopy |

Notes:

1. Nitrogen/protein conversion coefficient: 6.25;

2. Calculation formula by nutrient indication standard (Notice No. 146, 1996, by the Ministry of Health and Welfare): 100−(water+protein+lipid+ash+dietary fiber);

3. Energy conversion coefficient by nutrient indication standard (Notice No. 146, 1996, by the Ministry of Health and Welfare): protein 4; lipid 9; glucide 4;

4. By AOAC method.

TABLE 6
Analytical Result

| Analyzed Items | Result | Note | Analytical method |
|---|---|---|---|
| Riboflavin | 0.03 mg/100 g | | High speed liquid |
| (Vitamin B₂) | | | chromatography |
| Total | 2.4 mg/100 g | | High speed liquid |
| tocopherols | | | chromatography |
| (Vitamin E) | | | |
| α-tocopherol | 2.1 mg/100 g | | |
| γ-tocopherol | 0.3 mg/100 g | | |
| Pantothenic | 0.05 mg/100 g | 2 | Microorganism determination |
| acid | | | method |
| Biotin | 3.8 μg/100 g | 2 | Microorganism determination |
| | | | method |
| Inositol | 250 mg/100 g | 1 | Microorganism determination |
| | | | method |
| Niacin | 5.31 mg/100 g | 2 | Microorganism determination |
| | | | method |
| Choline | 0.07 g/100 g | 3 | |
| Linoleic acid | 0.86 g/100 g | | Gas chromatography |
| Linolenic acid | 0.03 g/100 g | | Gas chromatography |
| Pepsin | 31.5% | 4 | |
| digestion rate | | | |
| Phospholipid | 23 mg/100 g | 5 | |
| (as stearo oleo | | | |
| lecithin) | | | |
| Peroxide | 7.7 meq/kg | | Acetic acid-chloroform |
| number of | | | method |
| extracted oil | | | |
| Zinc | 2.03 mg/100 g | | Atomic absorption |
| | | | spectroscopy |
| Silicon | 1.26% | | ICP emission analytical |
| | | | method |

Notes:

1. Strain used: Saccharomyces cerevisiae (S. uvarum) ATCC 9080;

2. Strain used: Lactobacillus plantarum ATCC 8014;

3. By Reinecke's salt precipitation method;

4. Test condition: pepsin concentration, 0.2%; shaking digestion, 16 hours at 45° C.;

5. Tested in accordance with “Standard Methods for the Analysis of Oils, Fats and Derivatives” (compiled by Japan Oil Chemists' Society).

### COMPARATIVE EXAMPLE 2

30 kg of unpolished rice grains prepared by removing the hulls from the threshed rice grains were immersed in water for 30 minutes, then roasted for 3 hours and 10 minutes until the unpolished rice is roasted black. The temperature condition was substantially the same as that for Example 2. The roasted unpolished rice grains were pulverized into a fine powder having an average particle diameter of about 15 μm.

The analytical results of unpolished rice were as shown in Table 7:

TABLE 7
Analytical Result of Unpolished Rice

| Analyzed Items | Result | Note | Analytical Method |
|---|---|---|---|
| Water | 3.2 g/100 g | | Drying method by heating |
| | | | under normal pressure |
| Protein | 8.9 g/100 g | 1 | Kjeldahl method |
| Lipid | 2.8 g/100 g | | Acid decomposition method |
| Ash | 1.4 g/100 g | | Direct ashing method |
| Glucide | 80.8 g/100 g | 2 | |
| Energy | 399 kcal/ | 3 | |
| | 100 g | | |
| Dietary fiber | 2.9 g/100 g | | Henneberg Stomann improving |
| | | | method |
| Phosphorus | 384 mg/100 g | | Vanadomolybdic acid absorption |
| | | | spectroscopy |
| Iron | 1.66 mg/100 g | | O-phenanthroline absorption |
| | | | spectroscopy |
| Calcium | 12.1 mg/100 g | | Atomic absorption spectroscopy |
| Potassium | 271 mg/100 g | | Atomic absorption spectroscopy |
| Magnesium | 133 mg/100 g | | Atomic absorption spectroscopy |
| Total | 0.9 mg/100 g | | High speed liquid |
| tocopherols | | | chromatography |
| (Vitamin E) | | | |
| α-tocopherol | 0.6 mg/100 g | | |
| β-tocopherol | 0.1 mg/100 g | | |
| γ-tocopherol | 0.2 mg/100 g | | |
| Copper | 427 μg/100 g | | Atomic absorption spectroscopy |
| Zinc | 2.75 mg/100 g | | Atomic absorption spectroscopy |
| Manganese | 3.73 mg/100 g | | Atomic absorption spectroscopy |
| Silicon | 63 ppm | | Molybdic blue absorption |
| | | | Spectroscopy |
| Sodium | 1.4 mg/100 g | | Atomic absorption spectroscopy |

Notes:

1. Nitrogen/protein conversion coefficient: 5.95;

2. Calculation formula by nutrient indication standard (Notice No. 146, 1996, by the Ministry of Health and Welfare): 100−(water+protein+lipid+ash+dietary fiber);

3. Energy conversion coefficient by nutrient indication standard (Notice No. 146, 1996, by the Ministry of Health and Welfare): protein 3.47; lipid 8.37; carbohydrate (fiber+glucide) 4.12.

As shown in Tables 5, 6 and 7, the powder of the unhulled rice grains of the present invention (Example 2), which were roasted black, was found to contain 51.9 g of glucide and to have 268 kcal of energy per 100 g of the powder. On the other hand, the powder of the unpolished rice grains for Comparative Example 2, which were roasted black, was found to contain 80.8 g of glucide and to have 399 kcal of energy per 100 g of the powder. Clearly, the powder of the unhulled rice grains of the present invention provides a diet food having a very low energy, compared with the powder of the unpolished rice grains for Comparative Example 2. Still further, as compared with the powder of the present invention (Example 1), the powder in this Example 2 was found to provide a diet food having lower energy. Also, the powder of the unhulled rice grains of the present invention was found to contain 31.4 g of dietary fiber per 100 g of the powder; whereas, the powder of the unpolished rice grains for Comparative Example 2 was found to contain 2.9 g of dietary fiber per 100 g of the powder. In other words, the dietary fiber content of the powder of the present invention was 10.8 times as much as that for the powder of the unpolished rice grains for Comparative Example 2. Further, the powder of the present invention was found to contain 40.0 mg of iron and 21.7 mg of calcium per 100 g of the powder; whereas, the powder for Comparative Example 2 was found to contain 1.66 mg of iron and 12.1 mg of calcium per 100 g of the powder. In other words, the iron content and the calcium content of the powder of the present invention were about 24 times and 1.8 times as much, respectively, as the iron content and the calcium content for the powder of Comparative Example 2. Still further, the powder of the unhulled rice grains of the present invention was found to contain 2.4 mg of vitamin E per 100 g of the powder; whereas, the powder for Comparative Example 2 was found to contain 0.9 mg of vitamin E per 100 g of the powder. In other words, the vitamin E content of the powder of the present invention was about 2.7 times as much as that for the powder of Comparative Example 2.

As pointed out above, the experimental data clearly support that the powder of the unhulled rice grains of the present invention, which provides a good diet food, also provides an attractive food containing large amounts of minerals, having a high nutrient value and being excellent in digestive and absorptive properties.

The Examples described above are directed to powders of unhulled rice grains. However, similar effects can be expected in respect of powders of unhulled grains of barley, wheat, rye and oats.

As described above, unhulled rice grains or barley grains are roasted in the present invention, followed by powdering the roasted grains. The particular technique of the present invention makes it possible to solve the problem as to how to dispose of the hulls, though the hull was regarded in the past as agricultural waste material that is difficult to dispose of. In addition, the powder of the unhulled rice grains of the present invention has a high nutrient value, is excellent in digestive and absorptive properties, and provides foodstuff having a relatively lower calorie, compared with the powder of the unpolished rice grains.

1. A powder of unhulled cereal grains prepared by the following steps of:
impregnating unhulled cereal grains with water;
roasting said impregnated grains; and
powdering said roasted grains.

2. A powder of unhulled cereal grains cl aimed in claim 1 wherein said cereal grains comprise at least one cereal selected from the group of rice, barley, wheat, rye and oats.

3. A method of manufacturing a powder of unhulled cereal grains, comprising the steps of:
impregnating unhulled cereal grains with water for a predetermined time;
roasting said impregnated grains for a predetermined time; and
pulverizing the roasted grains into fine powder.

4. A method of manufacturing a powder of unhulled cereal grains claimed in claim 3 wherein said cereal grains comprise at least one cereal selected from the group of rice, barley, wheat, rye and oats.

5. A method of manufacturing a powder of unhulled cereal grains according to claim 3, wherein the unhulled cereal grains are roasted until the roasted grains are colored brown.

6. A method of manufacturing a powder of unhulled cereal grains according to claim 3, wherein the unhulled cereal grains are roasted until the roasted grains are colored black.
